(19) United States
(12) Patent Application Publication
(10) Pub. No.: US 2011/0228983 A1
(43) Pub. Date: Sep. 22, 2011

(54) INFORMATION PROCESSOR, INFORMATION PROCESSING METHOD AND PROGRAM

(76) Inventor: Kouichi Matsuda, Tokyo (JP)

(21) Appl. No.: 13/046,004

(22) Filed: Mar. 11, 2011

(30) Foreign Application Priority Data
Mar. 19, 2010 (JP) P2010-065115

(51) Int. Cl. G06K 9/00

(52) U.S. Cl. 382/103

(57) ABSTRACT

Disclosed herein is an information processor including, a storage section configured to store feature quantity data of a target object and audio data associated with the target object, an acquisition section configured to acquire an image of the target object, a recognition section configured to recognize an object included in the image based on the feature quantity data stored in the storage section and a reproduction section configured to reproduce the audio data associated with the recognized object and output a reproduced sound from an output device worn by the user.

### BACKGROUND OF THE INVENTION

1. Field of the Invention

The present invention relates to an information processor, information processing method and program and, more particularly, to an information processor, information processing method and program that allow for only a person looking at a certain object to hear a reproduced sound of audio data available in association with the object.

2. Description of the Related Art

In order to have those looking at an advertisement hear a sound related to the advertisement, a technique is available that outputs a sound from a speaker provided on the back or side of the advertisement (see, Japanese Patent Laid-Open No. 2004-77654).

Another technique is available that detects a person in front of an advertisement with a sensor such as camera installed on the wall on which the advertisement is posted so as to output a sound related to the advertisement (see, Japanese Patent Laid-Open No. 2001-142420).

### SUMMARY OF THE INVENTION

The above techniques are problematic in that, in the presence of persons not looking at the advertisement printed, for example, on a poster near the person looking at the advertisement, the sound is heard by those not looking at the advertisement as well as the person looking at it.

The above techniques are also problematic in that if a plurality of different posters are posted, the sounds from these posters are mixed, making it difficult to hear the sound of interest.

The above techniques are generally adopted in the hope of achieving better advertising effect by having only particular people hear the sound. However, these problems may rather result in reduced advertising effect.

The present invention has been made in light of the foregoing, and it is an aim of the present invention to have only the person looking at a certain object hear a reproduced sound of audio data available in association with the object.

According to an embodiment of the present invention, there is provided an information processor including:

storage means for storing feature quantity data of a target object and audio data associated with the target object;

acquisition means for acquiring an image of the target object;

recognition means for recognizing an object included in the image based on the feature quantity data stored in the storage means; and

reproduction means for reproducing the audio data associated with the recognized object and output a reproduced sound from an output device worn by the user.

The recognition means can recognize the positional relationship between the object included in the image and the user. The reproduction means can output the reproduced sound so that the reproduced sound is localized at the user position, with the installed position of the object included in the image set as the position of a sound source.

The storage means can store feature quantity data of a portion of the target object and audio data associated with the portion of the target object. The recognition means can recognize a portion of the target object included in the image based on the feature quantity data of the portion of the target object stored in the storage section. The reproduction means can reproduce the audio data associated with the portion of the target object recognized by the recognition means.

The information processor further including:

positioning means for detecting a position; and

communication means for communicating with a server having databases for the feature quantity data and audio data, the communication means also operable to download the feature quantity data of an object installed in an area including the position detected by the positioning means and the audio data associated with the object, wherein

the storage means stores the feature quantity data and audio data downloaded by the communication means.

According to another embodiment of the present invention there is provided an information processing method including the steps of:

storing feature quantity data of a target object and audio data associated with the target object;

acquiring an image of the target object;

recognizing an object included in the image based on the stored feature quantity data; and

reproducing the audio data associated with the recognized object and outputting a reproduced sound from an output device worn by the user.

According to yet another embodiment of the present invention there is provided a program causing a computer to perform a process, the process including the steps of:

storing feature quantity data of a target object and audio data associated with the target object;

acquiring an image of the target object;

recognizing an object included in the image based on the stored feature quantity data; and

reproducing the audio data associated with the recognized object and outputting a reproduced sound from an output device worn by the user.

According to an embodiment of the present invention, data representing feature quantity data of a target object and audio data associated with the target object are stored. An image of the target object is acquired. An object is recognized that is included in the image based on the stored feature quantity data. Further, the audio data associated with the recognized object is reproduced, and a reproduced sound is output from an output device worn by the user.

The present invention allows for only a person looking at a certain object to hear a reproduced sound of audio data available in association with the object.

### BRIEF DESCRIPTION OF THE DRAWINGS

FIG. 1 is a diagram illustrating an example of appearance of an AR system using an information processor according to an embodiment of the present invention;

FIG. 2 is a diagram illustrating an example of appearance of the user wearing an HMD;

FIG. 3 is a diagram illustrating an example of another appearance of the AR system;

FIG. 4 is a block diagram illustrating an example of hardware configuration of the information processor;

FIG. 5 is a block diagram illustrating an example of functional configuration of the information processor;

FIG. 6 is a diagram describing object recognition;

FIG. 7 is a flowchart describing an audio reproducing process performed by the information processor;

FIG. 8 is a block diagram illustrating another example of functional configuration of the information processor;

FIG. 9 is a flowchart showing a downloading process performed by the information processor configured as shown in FIG. 8;

FIG. 10 is a diagram illustrating segments specified in the poster;

FIG. 11 is a diagram illustrating an example of model data and audio data in association with the poster segments; and

FIG. 12 is a diagram illustrating an example of installation of the information processor.

### DETAILED DESCRIPTION OF THE PREFERRED EMBODIMENTS

### First Embodiment

### [AR (Augmented Reality) System]

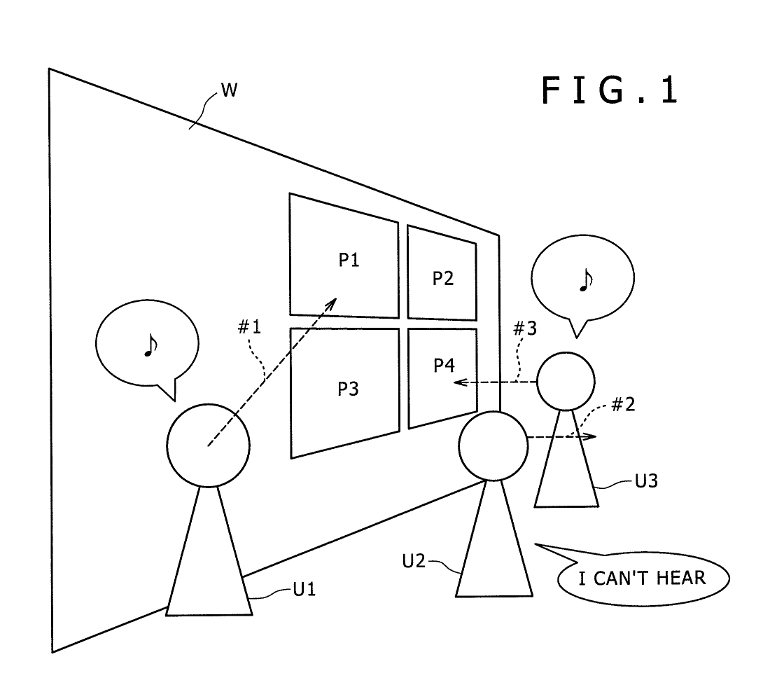

FIG. 1 is a diagram illustrating an example of appearance of an AR system using an information processor according to an embodiment of the present invention.

In the example shown in FIG. 1, posters P1 to P4 are posted side by side both horizontally and vertically on a wall surface W. Advertisements of products or services, for example, are printed on the posters P1 to P4.

Further, users U1 to U3 are standing in front of the wall surface W. The user U1 is looking at the poster P1, whereas the user U3 is looking at the poster P4. On the other hand, the user U2 is not looking at any of the posters P1 to P4 posted on the wall surface W. Dashed arrows #1 to #3 in FIG. 1 represent the lines of sight of the users U1 to U3, respectively.

In this case, a sound associated with the poster P1 is output in such a manner that only the user U1 looking at the poster P1 can hear the sound as shown by the balloon close to each of the users. Similarly, a sound associated with the poster P4 is output in such a manner that only the user U3 looking at the poster P4 can hear the sound. The sounds associated with the posters P1 and P4 cannot be heard by the user U2 not looking at the posters P1 and P4.

When detecting that the user carrying the information processor is looking at a poster, the information processor carried by that user reproduces the audio data associated with the poster and outputs a reproduced sound in such a manner that only that user can hear the sound. The audio data associated with the poster is, for example, audio or music data that introduces the product or service printed on the poster.

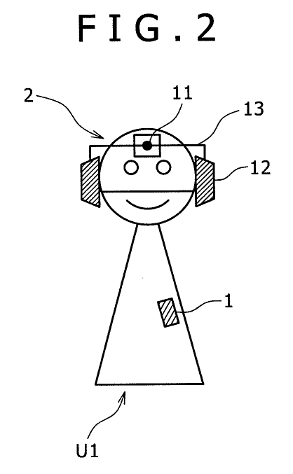

FIG. 2 is a diagram illustrating an example of appearance of the user U1 shown in FIG. 1.

As illustrated in FIG. 2, a user U1 carries an information processor 1 which is a portable computer. The user U1 also wears a head mounted display (HMD) 2. The information processor 1 and HMD 2 can communicate with each other in a wired or wireless fashion.

The HMD 2 has a camera 11, headphone 12, and display 13.

The camera 11 is attached where it can capture the scene in front of the user U1 wearing the HMD 2. The capture range of the camera 11 includes the line of sight of the user. The image captured by the camera 11 is transmitted to the information processor 1. The camera 11 continues to capture images (moving images) at a predetermined frame rate. This allows for images of the scene seen by the user to be supplied to the information processor 1.

The headphone 12 is attached so as to be placed over the ears of the user U1 wearing the HMD 2. The headphone 12 outputs a reproduced sound transmitted from the information processor 1.

A display 13 is attached in a way that the display comes in front of the eyes of the user U1 wearing the HMD 2. The display 13 includes a transparent member and displays, for example, information like an image or texts based on data transmitted from the information processor 1. The user can see the scene beyond the display 13. The user can also see the image shown on the display 13.

The users U2 and U3 each carry the information processor 1 and wear the HMD 2 as does the user U1.

For example, the information processor 1 carried by the user U1 recognizes the object to determine which poster is being seen by the user U1 based on the image captured by the camera 11. The information processor 1 stores object recognition data adapted to recognize which poster is being seen by the user. The object recognition data includes the posters P1 to P4.

This allows the particular user who are looking at the poster to hear a sound associated with the poster.

That is, there is no such problem as not only the person looking at the poster but also those not looking at the poster hearing the sound because the reproduced sound is output from the headphone 12. Further, there is also no such problem as difficulty in hearing the sound as a result of mixing of the sounds from the different advertisements because the sound data associated with one of the posters P1 to P4 is reproduced.

The audio data associated with a poster is reproduced while the user is looking the poster.

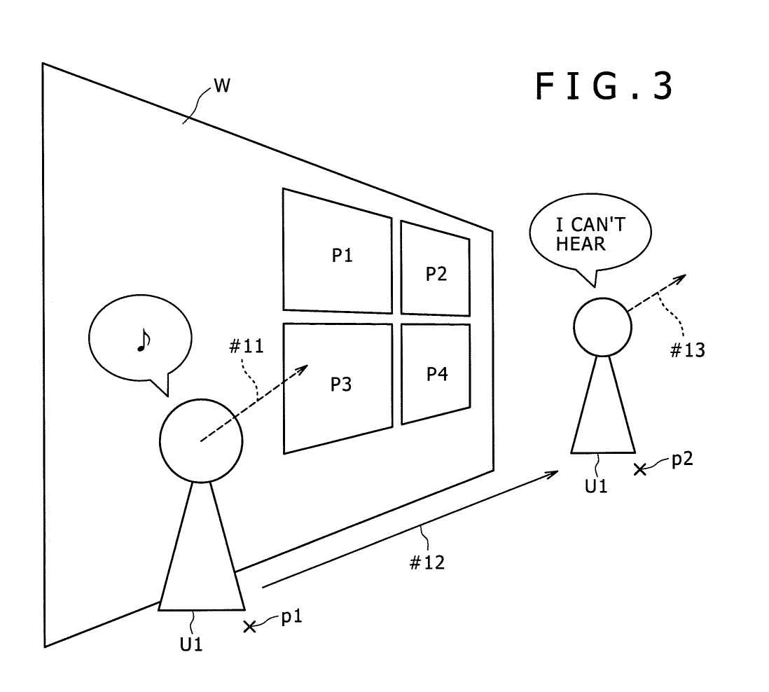

As illustrated in FIG. 3, for example, when the user U1 is looking at the poster P3 at a position p1 as illustrated by a dashed arrow #11, the audio data associated with the poster P3 is reproduced. The user U1 can hear a reproduced sound of the audio data associated with the poster P3.

On the other hand, if the user U1 is no longer looking at the poster P3 as illustrated by a dashed arrow #13 because he or she has moved to a position p2 as illustrated by a solid arrow #12, the reproduction of the audio data associated with the poster P3 is stopped. The user U1 cannot hear a reproduced sound of the audio data associated with the poster P3.

A description will be given later of a series of processes performed by the information processor 1 to control the reproduction of audio data as described above.

### [Configuration of the Information Processor]

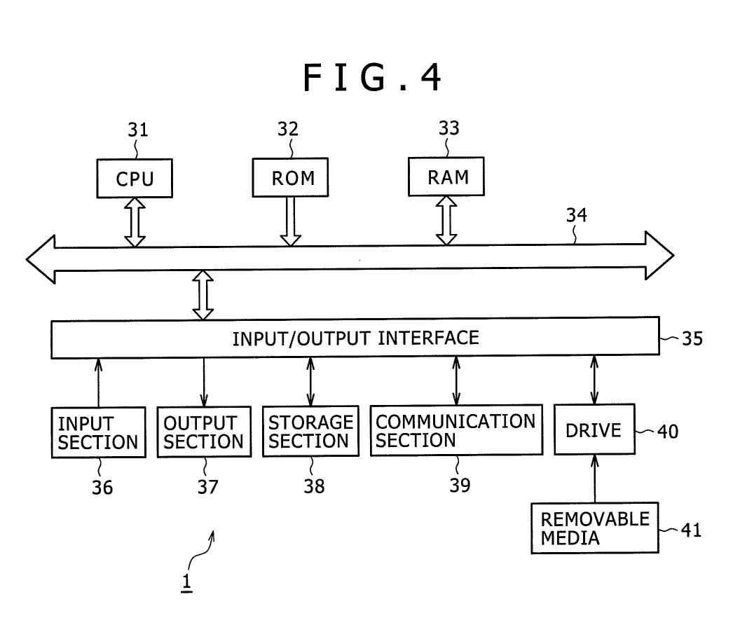

FIG. 4 is a block diagram illustrating an example of hardware configuration of the information processor 1.

A CPU (Central Processing Unit) 31, ROM (Read Only Memory) 32 and RAM (Random Access Memory) 33 are connected to each other via a bus 34.

An I/O interface 35 is also connected to the bus 34. An input section 36, output section 37, storage section 38, communication section 39 and drive 40 are connected to the I/O interface 35.

The input section 36 communicates with the HMD 2 and receives images captured by the camera 11 of the HMD 2.

The output section 37 communicates with the MMD 2 and outputs a reproduced sound of the audio data from the headphone 12. Further, the output section 37 transmits display data to the HMD 2 to display information such as images and text on the display 13.

The storage section 38 includes, for example, a hard disk or non-volatile memory and stores recognition data for posters and audio data associated with each poster.

The communication section 39 includes, for example, a network interface such as wireless LAN (Local Area Network) module and communicates with servers connected via networks. Recognition for posters and audio data stored in the storage section 38 are, for example, downloaded from a server and supplied to the information processor 1.

The drive 40 reads data from a removable medium 41 loaded in the drive 40 and writes data to the removable medium 41.

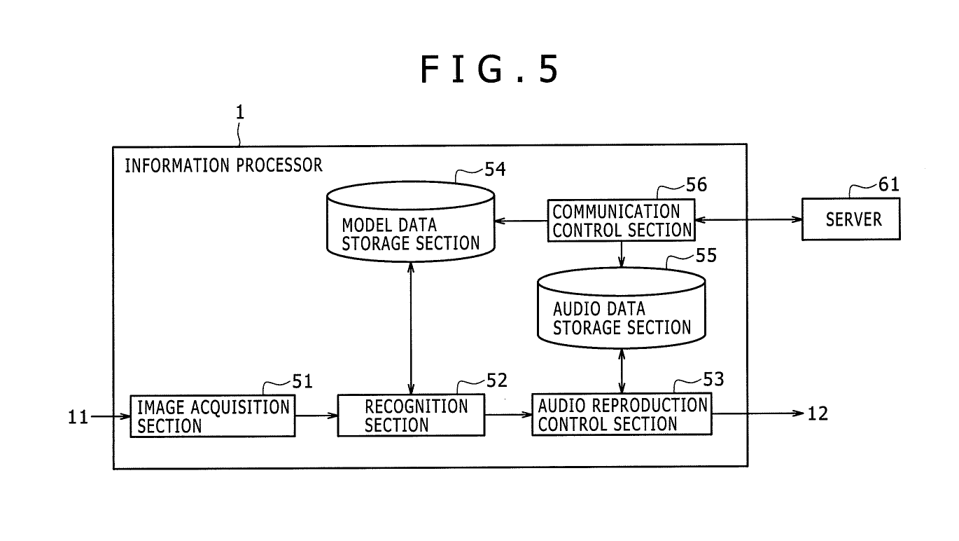

FIG. 5 is a block diagram illustrating an example of functional configuration of the information processor 1.

An image acquisition section 51, recognition section 52, audio reproduction control section 53, model data storage section 54, audio data storage section 55 and communication control section 56, are materialized in the information processor 1. At least some of the sections are implemented as a result of execution of a predetermined program by the CPU 31 shown in FIG. 4. The model data storage section 54 and the audio data storage section 55 are formed, for example, as the storage section 38.

The image acquisition section 51 acquires an image, captured by the camera 11, that has been received by the input section 36. The image acquisition section 51 outputs the acquired image to the recognition section 52.

The recognition section 52 receives the image from the image acquisition section 51 as a query image and recognizes the object included in the image based on model data stored in the model data storage section 54. The model data storage section 54 stores data representing the features of the poster extracted from the image including the poster. The object recognition performed by the recognition section 52 will be described later.

The recognition section 52 outputs, for example, the ID of the recognized object (poster) and posture information representing the relative positional relationship between the recognized poster and camera 11 (user) to the audio reproduction control section 53 as a recognition result. For example, the distance to and the direction of the user from the recognized poster are identified based on the posture information.

The audio reproduction control section 53 reads the audio data, associated with the ID supplied from the recognition section 52, from the audio data storage section 55, thus reproducing the audio data. The audio reproduction control section 53 controls the output section 37 shown in FIG. 4 to transmit the reproduced audio data, obtained by the reproduction, to the HMD 2. The reproduced audio data is output from the headphone 12. The audio data storage section 55 stores the poster IDs in association with the audio data.

The communication control section 56 controls the communication section 39 to communicate with a server 61 and downloads model data used for recognition of the features of the poster and audio data associated with the. The server 61 has databases for the model data and audio data. The communication control section 56 stores the downloaded model data in the model data storage section 54 and the downloaded audio data in the audio data storage section 55.

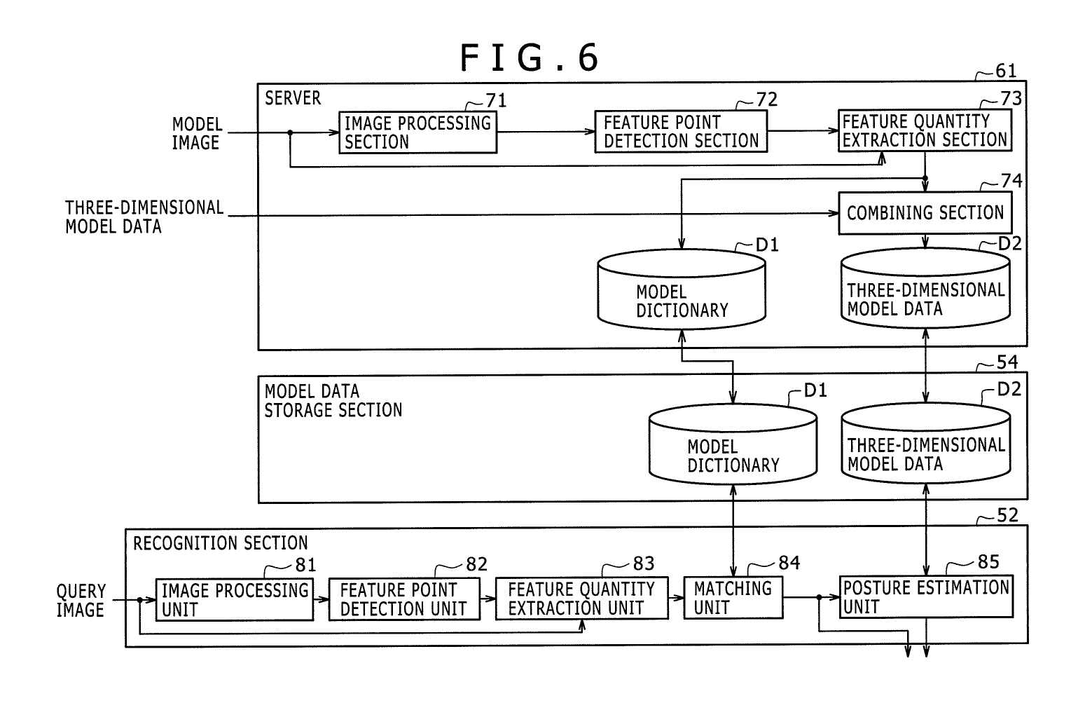

FIG. 6 is a diagram describing object (poster) recognition.

Among the algorithms used by the recognition section 52 are RandomizedFern and SIFT (Scale Invariant Feature Transform. RandomizedFern is disclosed in “Fast Keypoint Recognition using Random Ferns Mustafa Ozuysal, Michael Calonder, Vincent Le Petite and Pascal FuaEcole Polytechnique Federale de Lausanne (EPEL) Computer Vision Laboratory, &C Faculty CH-1015 Lausanne, Switzerland.” On the hand, SIFT is disclosed in “Distinctive Image Features from Scale-Invariant Keypoints David G. Lowe Jan. 5, 2004.”

As illustrated in FIG. 6, an image processing section 71, feature point detection section 72, feature quantity extraction section 73 and combining section 74 are materialized in the server 61 which is a learning device. All the sections shown in FIG. 6 are materialized as a result of execution of a predetermined program by the CPU of the server 61. The server 61 also includes a computer as shown in FIG. 4.

The image processing section 71 applies affine transform or other process to a model image and outputs the resultant model image to the feature point detection section 72. Each image of poster P1 to P4 is sequentially fed to the image processing section 71 as model images. The model images are also fed to the feature quantity extraction section 73.

The feature point detection section 72 determines the points in the model image, supplied from the image processing section 71, as model feature points and outputs the information representing the positions of the model feature points to the feature quantity extraction section 73.

The feature quantity extraction section 73 extracts, as model feature quantities, information of the pixels whose positions are corresponding to the positions of the model feature points from among the pixels making up the model image. The model feature quantity data extracted by the feature quantity extraction section 73 is registered in a model dictionary D1 in association with the ID of the poster included in the model image from which the feature quantity was extracted. The model dictionary D1 includes data that associates the ID of the poster with the model feature quantity data for each of the model feature points extracted from the image including the poster.

Further, the feature quantity extraction section 73 outputs the extracted model feature quantity data to the combining section 74.

The combining section 74 combines input three-dimensional model data and model feature quantity data supplied from the feature quantity extraction section 73. Data that represents the form of three-dimension corresponding to each poster P1 to P4 is input as three-dimensional model data to the combining section 74.

For example, the combining section 74 calculates, based on the three-dimensional model data, the position on the three-dimensional model of each of the model feature points when the poster is viewed from various angles. The combining section 74 assigns the model feature quantity data to each of the calculated positions of the model feature points, thus combining the three-dimensional model data and model feature quantity data and generating three-dimensional model data D2.

The model dictionary D1 and three-dimensional model data D2 generated by the combining section 74 are supplied to the information processor 1 and stored in the model data storage section 54.

As illustrated in FIG. 6, the recognition section 52 includes an image processing unit 81, feature point detection unit 82, feature quantity extraction unit 83, matching unit 84 and posture estimation unit 85. An image captured by the camera 11 and acquired by the image acquisition section 51 is fed to the image processing unit 81 as a query image. This query image is also supplied to the feature quantity extraction unit 83.

The image processing unit 81 applies affine transform or other process to the query image and outputs the resultant query image to the feature point detection unit 82 as does the image processing section 71.

The feature point detection unit 82 determines the points in the query image, supplied from the image processing unit 81, as query feature points and outputs the information representing the positions of the query feature points to the feature quantity extraction unit 83.

The feature quantity extraction unit 83 extracts, as query feature quantities, information of the pixels whose positions are corresponding to the positions of the query feature points from among the pixels making up the query image. The feature quantity extraction unit 83 outputs the extracted query feature quantity data to the matching unit 84.

The matching unit 84 performs a K-NN search or other nearest neighbor search based on the feature quantity data included in the model dictionary D1, thus determining the model feature point that is the closest to each query feature point. The matching unit 84 selects, for example, the poster having the largest number of closest model feature points based on the number of model feature points closest to the query feature points. The matching unit 84 outputs the ID of the selected poster as a recognition result.

The ID of the poster output from the matching unit 84 is supplied not only to the audio reproduction control section 53 shown in FIG. 5 but also to the posture estimation unit 85. The posture estimation unit 85 is also supplied with information representing the position of each of the query feature points.

The posture estimation unit 85 reads the three-dimensional model data D2 of the poster recognized by the matching unit 84 from the model data storage section 54. The posture estimation unit 85 identifies, based on the three-dimensional model data D2, the position on the three-dimensional model of the model feature point closest to each of the query feature points. The posture estimation unit 85 outputs posture information representing the positional relationship between the poster and user.

If the position on the three-dimensional model of the model feature point closest to each of the query feature points, detected from the query image captured by the camera 11, can be identified, it is possible to determine from which position of the poster the query image was captured, i.e., where the user is.

Further, if the size of and distance to the poster included in the image are associated with each other in advance, it is possible to determine, based on the size of the poster included in the query image captured by the camera 11, the distance from the poster to the user. The lens of the camera 11 is, for example, a single focus lens with no zooming capability.

The relative positional relationship between the poster looked by the user and the user is recognized as described above.

### [Operation of the Information Processor]

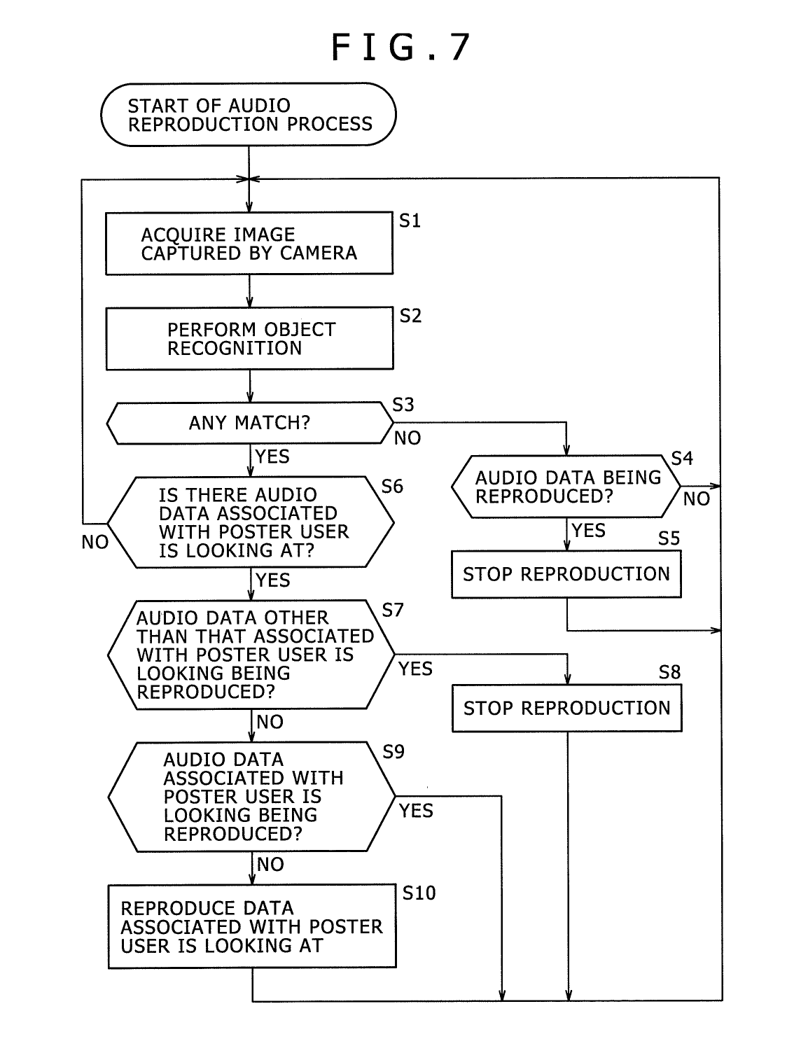

A description will be given here of the audio reproducing process performed by the information processor 1 with reference to the flowchart shown in FIG. 7. The process shown in FIG. 7 is repeated, for example, during image capture by the camera 11.

In step S1, the image acquisition section 51 acquires an image captured by the camera 11.

In step S2, the recognition section 52 performs object recognition in the image acquired by the image acquisition section 51.

In step S3, the recognition section 52 determines whether the ID matching that of the recognized object is stored in the model data storage section 54 as a poster ID, that is, whether the user is looking at the poster.

If it is determined in step S3 that the user is not looking at the poster, the audio reproduction control section 53 determines in step S4 whether that audio data is being reproduced.

When it is determined in step S4 that audio data is being reproduced, the audio reproduction control section 53 stops the reproduction of audio data in step S5. When the reproduction of audio data is stopped in step S5 or if it is determined in step S4 that audio data is not being reproduced, the process returns to step S1 to repeat the process steps that follow.

On the other hand, when it is determined in step S3 that the user is looking the poster, the audio reproduction control section 53 determines in step S6 whether audio data associated with the poster at which the user is looking is stored in the audio data storage section 55.

If it is determined in step S6 that audio data associated with the poster at which the user is looking is not stored in the audio data storage section 55, the process returns to step S1 to repeat the process steps that follow.

When it is determined in step S6 that audio data associated with the poster at which the user is looking is stored in the audio data storage section 55, the audio reproduction control section 53 determines in step S7 whether audio data other than that associated with the poster at which the user is looking is being reproduced.

When it is determined in step S7 that audio data other than that associated with the poster at which the user is looking is being reproduced, the audio reproduction control section 53 stops the reproduction of the audio data. When the reproduction of the audio data is stopped in step S8, the process returns to step S1 to repeat the process steps that follow.

On the other hand, if it is determined in step S7 that audio data other than that associated with the poster at which the user is looking is not being reproduced, the audio reproduction control section 53 determines in step S9 whether the audio data associated with the poster at which the user is looking is being reproduced.

When it is determined in step S9 that the audio data associated with the poster at which the user is looking is being reproduced, the process returns to step S1 to repeat the process steps that follow. In this case, the audio data associated with the poster at which the user is looking continues to be reproduced.

If it is determined in step S9 that the audio data associated with the poster at which the user is looking is not being reproduced, the audio reproduction control section 53 reads the audio data associated with the poster at which the user is looking from the audio data storage section 55, thus initiating the reproduction. Then, the process steps from step S1 and beyond are repeated.

The above process steps allow for only the person looking at a poster to hear a reproduced sound of audio data associated with the poster.

When a plurality of posters are recognized to be included in the image captured by the camera 11, the poster closest to the center of the image may be recognized as the poster the user is looking at.

The sound volume output from the left and right speakers of the headphone 12 and the output timing may be adjusted so that the reproduced sound is localized at the user position represented by posture information, with the position of the poster recognized to be looked by the user set as the position of the sound source. This makes it possible to give an impression to the user that the sound is being output from the poster.

### Modification Example

Model data stored in the model data storage section 54 and audio data stored in the audio data storage section 55 may be updated according to the user position.

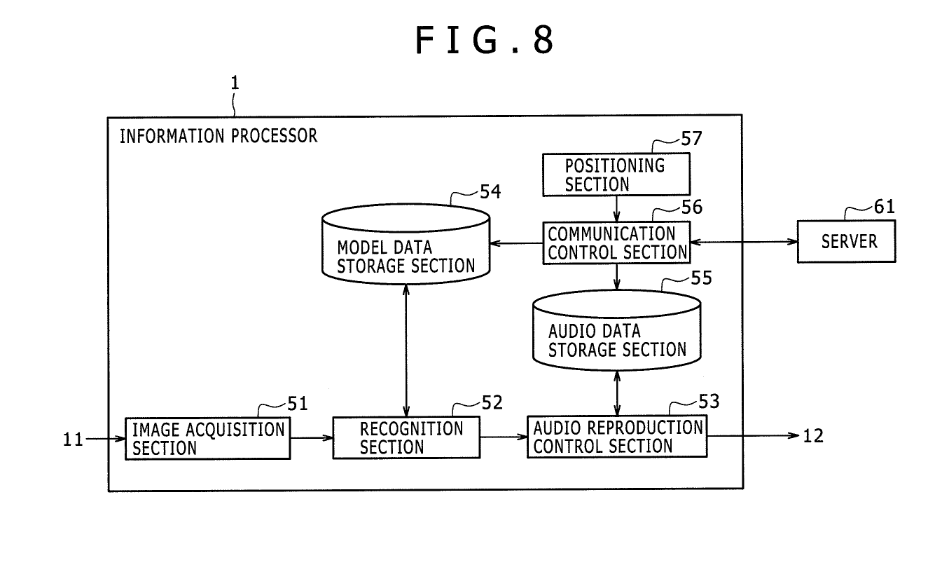

FIG. 8 is a block diagram illustrating another example of functional configuration of the information processor 1.

The configuration shown in FIG. 8 is identical to that shown in FIG. 5 except that a positioning section 57 is added. The description is omitted where redundant.

The positioning section 57 detects the position of the information processor 1, i.e., the position of the user carrying the information processor 1, based on the output of the GPS (Global Positioning System) sensor (not shown) provided in the information processor 1. The positioning section 57 outputs position information representing the current position to the communication control section 56.

The communication control section 56 transmits position information to the server 61 and downloads the model data of the posters posted in the area including the current position and the audio data associated with the posters.

In the server 61, the poster model data and audio data are classified by area for management. The model data and audio data are downloaded, for example, in units of a set of model data and audio data related to the posters posted in one area.

The communication control section 56 stores the downloaded model data in the model data storage section 54 and the downloaded audio data in the audio data storage section 55.

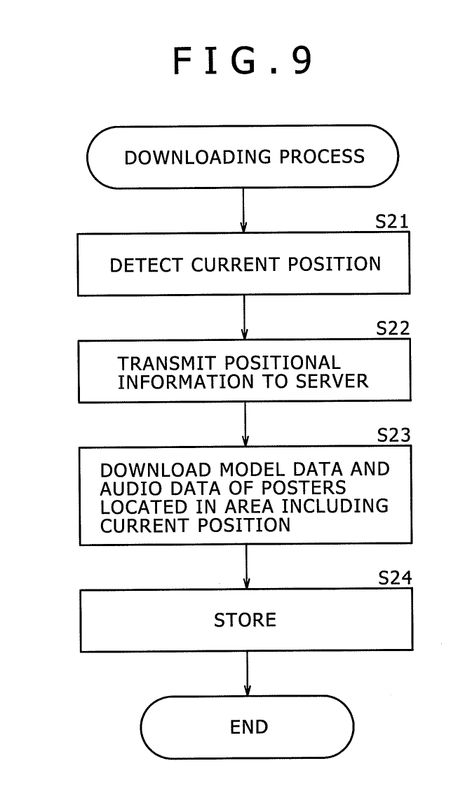

A description will be given below of the downloading process performed by the information processor 1 configured as shown in FIG. 8 with reference to the flowchart shown in FIG. 9.

In step S21, the positioning section 57 detects the current position and outputs the position information to the communication control section 56.

In step S22, the communication control section 56 transmits the position information to the server 61.

In step S23, the communication control section 56 downloads the model data of the posters posted in the area including the current position and the audio data associated with the posters.

In step S24, the communication control section 56 stores the downloaded model data in the model data storage section 54 and the downloaded audio data in the audio data storage section 55, after which the process is terminated.

The model data and audio data of the posters posted in the area including the immediately previous current position of the user may be deleted respectively from the model data storage section 54 and audio data storage section 55 after new downloaded model data and audio data are stored. This contributes to reduction in amount of model data and audio data.

Although it was described above that which poster is looked at by the user is recognized on a poster-by-poster basis and that, as a result of this, the audio data associated with the poster is reproduced, the above process may be performed on a segment-by-segment basis of a single poster. In this case, which segment of the poster is being looked by the user is recognized, and the audio data associated with the recognized segment of the poster is reproduced.

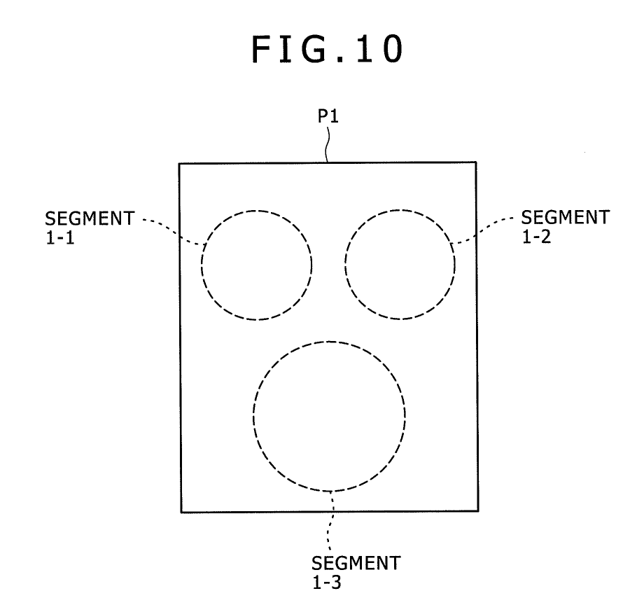

FIG. 10 is a diagram illustrating segments (regions) specified in the poster P1.

In the example shown in FIG. 10, segments 1-1, 1-2 and 1-3 are specified in the poster P1. Different contents of information such as different product photographs are printed respectively in the segments 1-1, 1-2 and 1-3.

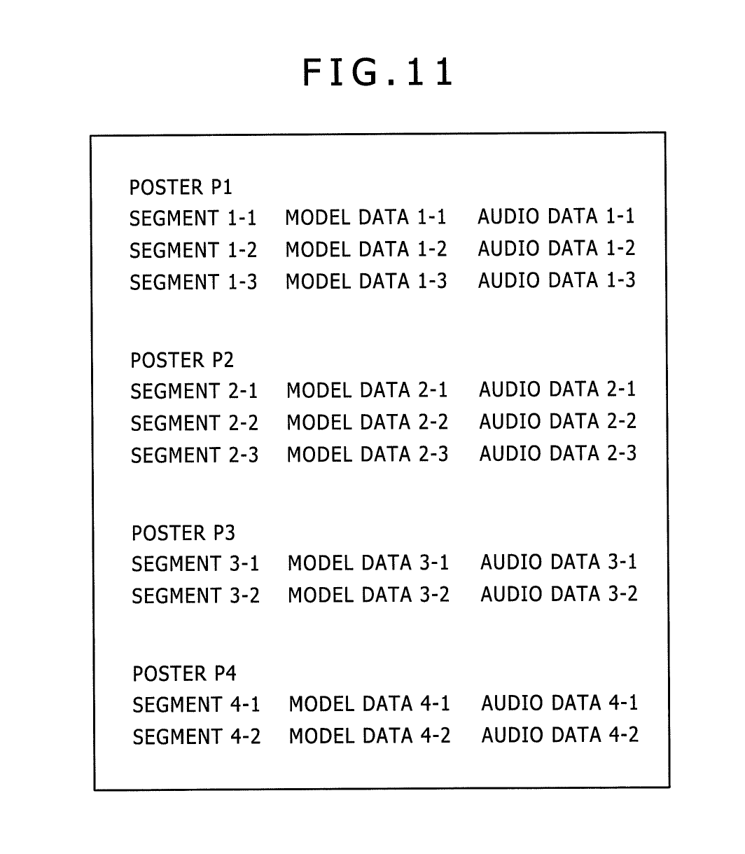

Model data and audio data are stored in the information processor 1 in association with the poster segments as illustrated in FIG. 11.

In the example shown in FIG. 11, model data 1-1 and audio data 1-1 are stored in association with the segment 1-1 of the poster P1. Model data 1-2 and audio data 1-2 are stored in association with the segment 1-2 of the poster P1. Model data 1-3 and audio data 1-3 are stored in association with the segment 1-3 of the poster P1.

Similarly, model data and audio data are stored in the information processor 1 in association with each of the fragments of the poster for the posters P2 to P4.

The reproduction of the audio data 1-1 begins when the information processor 1 determines that the user is looking at the segment 1-1 of the poster P1 based on the image captured by the camera 11 and segment-by-segment model data.

This makes it possible to change the audio data to be heard by the user according to the poster segment which the user is looking at.

Although it was described above that the information processor 1 is carried by the user, the information processor 1 may be installed at other location.

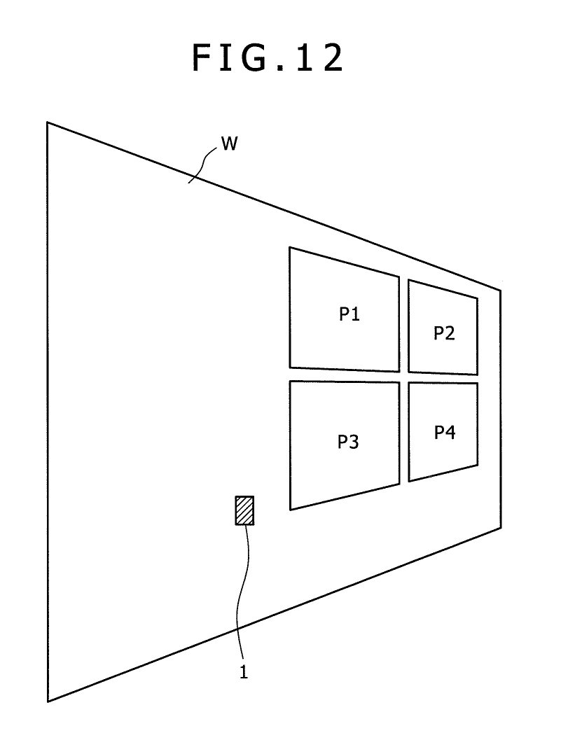

FIG. 12 is a diagram illustrating an example of installation of the information processor 1.

In the example shown in FIG. 12, the information processor 1 is installed on the wall surface W on which the posters P1 to P4 are posted. The information processor 1 communicates with the HMD 2 worn by the user so that images captured by the camera 11 and audio data reproduced by the information processor 1 are exchanged between the two devices.

Although a description was given above of a case in which the target objects are posters, an image or images displayed on a display may be recognized so that audio data associated with the recognized image or images is reproduced.

Although a description was given above of a case in which the information processor 1 communicates with the HMD 2, the information processor 1 may instead communicate with other type of device carried by the user such as mobile music player with camera function. The user can hear the sound associated with a poster with earphones of the mobile music player by capturing the poster with the mobile music player.

The type of audio data to be reproduced may be selectable. For example, if a plurality of voices, each intended for a different age group, such as one for adults and another for children, are available in association with the same poster, the voice selected by the user is reproduced.

In this case, the user selects in advance whether to reproduce the voice intended for adults or children and stores information representing his or her selection in the information processor 1. If it is detected that the user is looking at a poster, the information processor 1 begins to reproduce the type of audio data represented by the stored information of all the pieces of audio data associated with the poster. This allows for the user to listen to the voice of his or her preference.

Further, the user may be able to select the language in which to reproduce the voice from among different languages such as one in Japanese and another in other language.

It should be noted that the above series of processes may be performed by hardware or software. If the series of processes are performed by software, the program making up the software is installed from a program recording medium to a computer incorporated in dedicated hardware, a general-purpose personal computer or other computer.

The program to be installed is supplied recorded on a removable medium 41 shown in FIG. 4 such as optical disc (e.g., CD-ROM (Compact Disc-Read Only Memory), DVD (Digital Versatile Disc)) or semiconductor memory. Alternatively, the program may be supplied via a wired or wireless transmission medium such as local area network, the Internet or digital broadcasting. The program may be installed in advance to the ROM 32 or storage section 38.

The program executed by a computer may include not only the processes performed chronologically according to the described sequence but also those that are performed in parallel or when necessary as when invoked.

The embodiments of the present invention are not limited to those described above, but may be modified in various manners without departing from the spirit and scope of the present invention.

The present application contains subject matter related to that disclosed in Japanese Priority Patent Application JP 2010-065115 filed in the Japan Patent Office on Mar. 19, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processor comprising:
storage means for storing feature quantity data of a target object and audio data associated with the target object;
acquisition means for acquiring an image of the target object;
recognition means for recognizing an object included in the image based on the feature quantity data stored in the storage means; and
reproduction means for reproducing the audio data associated with the recognized object and output a reproduced sound from an output device worn by the user.

2. The information processor of claim 1, wherein
the recognition means recognizes the positional relationship between the object included in the image and the user, and
the reproduction means outputs the reproduced sound so that the reproduced sound is localized at the user position, with the installed position of the object included in the image set as the position of a sound source.

3. The information processor of claim 1, wherein
the storage means stores feature quantity data of a portion of the target object and audio data associated with the portion of the target object,
the recognition means recognizes a portion of the target object included in the image based on the feature quantity data of the portion of the target object stored in the storage section, and
the reproduction means reproduces the audio data associated with the portion of the target object recognized by the recognition means.

4. The information processor of claim 1 further comprising:
positioning means for detecting a position; and
communication means for communicating with a server having databases for the feature quantity data and audio data, the communication means also operable to download the feature quantity data of an object installed in an area including the position detected by the positioning means and the audio data associated with the object, wherein
the storage means stores the feature quantity data and audio data downloaded by the communication means.

5. An information processing method comprising the steps of:
storing feature quantity data of a target object and audio data associated with the target object;
acquiring an image of the target object;
recognizing an object included in the image based on the stored feature quantity data; and
reproducing the audio data associated with the recognized object and outputting a reproduced sound from an output device worn by the user.

6. A program causing a computer to perform a process, the process comprising the steps of:
storing feature quantity data of a target object and audio data associated with the target object;
acquiring an image of the target object;
recognizing an object included in the image based on the stored feature quantity data; and
reproducing the audio data associated with the recognized object and outputting a reproduced sound from an output device worn by the user.

7. An information processor comprising:
a storage section configured to store feature quantity data of a target object and audio data associated with the target object;
an acquisition section configured to acquire an image of the target object;
a recognition section configured to recognize an object included in the image based on the feature quantity data stored in the storage section; and
a reproduction section configured to reproduce the audio data associated with the recognized object and output a reproduced sound from an output device worn by the user.
